(19) United States
(12) Patent Application Publication
(10) Pub. No.: US 2021/0065237 A1
(43) Pub. Date: Mar. 4, 2021

(54) Method and System of Providing Search Results to Users

(71) Applicant: MICROSOFT TECHNOLOGY LICENSING, LLC, Redmond, WA (US)

(72) Inventor: Aleksander ØHRN, Oslo (NO)

(73) Assignee: MICROSOFT TECHNOLOGY LICENSING, LLC, Redmond, WA (US)

(21) Appl. No.: 16/560,609

(22) Filed: Sep. 4, 2019

(51) Int. Cl. G06Q 30/02; G06F 16/957; G06F 16/9535; G06F 16/955

(52) U.S. Cl. CPC G06Q 30/0256; G06F 16/9566; G06F 16/9535; G06F 16/9574

(57) ABSTRACT

A method of and system for display of a search result ad include receiving over a network a search term for which a targeted notification d is to be generated, receiving data associated with the search term, generating a creative for the targeted notification based in part on the data received and the search term, determining targeting criteria for the targeted notification; and providing the creative and the targeting criteria to an advertising service over the network to enable displaying the targeted notification, wherein the targeted notification provides notification of search results available for the search term, and a landing page for the creative is a search engine results page (SERP) for the search term.

### TECHNICAL FIELD

This disclosure relates generally to providing customized search results for users, and more particularly, to a method and system of notifying users of search results tailored to users via an advertising mechanism.

### BACKGROUND

In recent years, many webpages and applications have begun displaying ads for various products or services. Each ad is often associated with a specific product, service or entity, and is usually provided to encourage the users to visit a webpage related to the specific product, service or entity to make a purchase. While this may be beneficial to the entity that provides the products or services, it may not always be advantageous to the user.

Search engines are often used to search for items of interest to a user. When a search is performed by a search engine, a list of the most relevant search results may be displayed on search engine results pages (SERPs). To perform a search, however, the user often needs to visit the webpage for the search engine and enter a search term into a user interface (UI) element. The results may then be displayed on a SERP for the user to view and peruse. This requires the user to visit a particular page and perform certain actions to obtain desired search results.

Hence, there is a need for an improved method and system of providing customized search results to users.

### SUMMARY

To address these issues and more, in one general aspect, the instant disclosure presents a data processing system having a processor and a memory in communication with the processor, where the memory stores executable instructions that, when executed by the processor, cause the data processing system to perform multiple functions. The function may include receiving over a network a search term for which a targeted notification is to be generated, receiving data associated with the search term, generating a creative for the targeted notification based in part on the data received and the search term, determining targeting criteria for the targeted notification; and providing the creative and the targeting criteria to an advertising service over the network to enable displaying the targeted notification, wherein the targeted notification provides notification of search results available for the search term, and a landing page for the creative is a SERP for the search term.

In yet another general aspect, the instant application describes a method for enabling display of a targeted notification. The method may include receiving over a network a search term for which a targeted notification is to be generated, receiving data associated with the search term, generating a creative for the targeted notification based in part on the data received and the search term, determining targeting criteria for the targeted notification; and providing the creative and the targeting criteria to an advertising service over the network to enable displaying the targeted notification, wherein the targeted notification provides notification of search results available for the search term, and a landing page for the creative is a SERP for the search term.

In a further general aspect, the instant application describes a non-transitory computer readable medium on which are stored instructions that when executed cause a programmable device to receive over a network a search term for which a targeted notification is to be generated, receive data associated with the search term, generating a creative for the targeted notification based in part on the data received and the search term, determine targeting criteria for the targeted notification; and provide the creative and the targeting criteria to an advertising service over the network to enable displaying the targeted notification, wherein the targeted notification provides notification of search results available for the search term, and a landing page for the creative is a SERP for the search term.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system upon which aspects of this disclosure may be implemented.

FIGS. 2A-2B depict example UI screens associated with a search engine which may be presented to a user for conducting a search.

FIGS. 3A-3B depict example UI screens of webpages displaying search result ads.

FIG. 4 depicts an example UI screens that displays an ad notifying a user that a new search result has become available.

FIG. 5 is a flow diagram depicting an example method for providing search results as advertisements.

FIG. 6 is a block diagram illustrating an example software architecture, various portions of which may be used in conjunction with various hardware architectures herein described.

FIG. 7 is a block diagram illustrating components of an example machine configured to read instructions from a machine-readable medium and perform any of the features described herein.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well-known methods, procedures, components, and/or circuitry have been described at a relatively high level, without detail, in order to avoid unnecessarily obscuring aspects of the present teachings.

Many webpages and applications provide mechanisms for displaying advertising on the webpage or pages of the application. Advertising provided on such webpages or applications are often targeted to specific users based on many different factors. To provide targeted ads to appropriate users, different advertising platforms have been developed that enable displaying ads to users under certain criteria. However, the mechanisms used for providing ads to users are currently used primarily to provide advertisements for products or services that are intended to encourage a user to make a purchase. As such, most of these ads are provided to benefit the advertising entity and not necessarily provide information or resources to the user.

To gain access to certain information or resources, users often conduct a search in a search engine. This may require that the user visits a search engine webpage or application, enter a search query and wait until a SERP is displayed. Once the user moves away from the SERP, to gain access to the search results, the user would need to repeat the steps of visiting the search engine page and entering a search query. Furthermore, if a new relevant search result becomes available after the user has performed a search, there is often no convenient way for the user to learn of the new results, unless the user returns to the search engine. Some search engines allow for creating standing queries for searching by enabling the user to request such a query and provide a valid email address at which they can receive updates when the search engine runs the query on a predetermined schedule and new results are identified. This may be inconvenient, time-consuming and inefficient. Furthermore, most users have a preferred search engine that they use. While this may be convenient to the user, it may not always provide the most relevant search results, as different search engines may provide different results. Sometimes a search engine a user does not often use may provide more relevant results than one the user commonly utilizes.

To address these technical problems and more, in an example, this description provides a technical solution for providing search results for search queries a user may be interested in as ads displayed on webpages or applications the user visits. To improve the current methods of providing search results, the technical solution may identify a number of search queries as the most appropriate queries to use for advertising. The most appropriate search queries may be identified based on a variety of parameters, including most frequently searched for queries (e.g., most frequently used search queries in the a given time period), queries from which the search engine can profit more (e.g., queries that produce results providing more fees), and the like. Once a given set of search queries are identified, SERPs (or URLs) for those search queries may be provided to a service that generates a creative for each of the identified search queries. The creatives may include text, image, and/or other content relating to the search query or the search results. For example, a creative may display a listing of one or more search results provided on the SERP page for the query. The generated creatives may then be transmitted to an advertising service along with one or more criteria for providing each creative as an ad on a webpage or application. As a result, the technical solution provides an improved user experience for users which allows them to gain quick access to search results that are relevant to them.

As will be understood by persons of skill in the art upon reading this disclosure, benefits and advantages provided by such technical solutions can include, but are not limited to, a solution to the technical problem of users not being able to quickly and efficiently gain access to search results, be notified of new relevant search results for queries they have made in the past and make use of different search engines. Technical solutions and implementations provided here optimize and improve the process of providing search results and encouraging more use of a search engine. The benefits provided by these technical solutions include improving user experience, saving time and providing solutions for more efficient access to information.

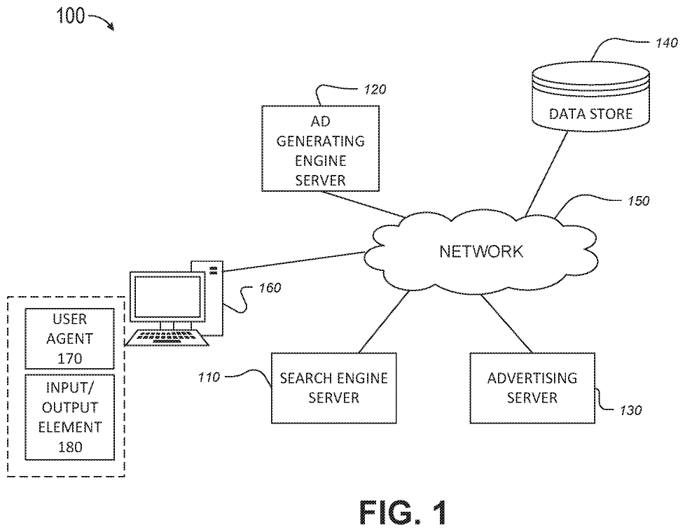

FIG. 1 illustrates an example system 100, upon which aspects of this disclosure may be implemented. The system 100 may include a search engine sever 110, an ad generating engine server 120, and an advertising server 130, all of which may be connected to or include a data store 140 in which data relating to search engine queries, advertising services and ad generating services may be stored. It should be noted that although only one data store 140 is shown, each of the search engine server 110, ad generating engine server 120, and advertising server 130 may be connected to its own data store. Moreover, each of the search engine server 110, ad generating engine server 120, and advertising server 130 may include a plurality of servers that work together to deliver the functions and services provided by each server. Each of the search engine server 110, ad generating engine server 120, and advertising server 130 may also operate as a shared resource server accessible by various computer client devices such as client device 160.

The search engine server 110 may be a public search engine or an enterprise search engine targeted specifically for searches within an enterprise. The search engine server 110 may be responsible for receiving queries, searching available datasets (e.g., an index of webpages), and providing relevant search engine results, among many other features. The results may include lists of webpage titles, snippets of text extracted from those webpages (or summaries provided by the webpages), and links to the webpages. In an example, the list of webpages may be grouped into a predetermined number of SERPs each showing a specific number of search results. In addition to receiving search queries and providing search results, the search engine server 110 may also keep track of the number of queries received for a given search term, the number of search results provided for the given search term, and the amount of revenue generated by the given search query. In an example, one or more of these factors may be taken into account in identifying a list of search queries for which search result ads should be generated. The number of queries on the list of identified search queries may vary depending on the search engine and other variables. For example, for a given search engine, the 200 most frequently searched queries on the search engine may be identified as search queries for which ads should be generated. This list may be updated based on a predetermined schedule (e.g., once every 24 hours, once a week, etc.).

Once the list of identified search queries has been determined, the search engine server 110 may keep track of the top search results for each of the queries on the list. This may be done to determine if new relevant search results are available for a given query. For example, if a new article has been published on the subject of a search query and the new article is identified as being in a predetermined top range of search results (e.g., the top 10 search results), the search engine server 110 may identify that query as having a new search result. This information may be transferred to the ad generating engine server 120 to enable creation of a new updated creative for the search term and/or providing notifications for the updated search results to users who may be interested in learning about the new search result.

The ad generating engine server 120 may be responsible for receiving information about the identified search queries from the search engine server 110 and generating a creative for each of the identified search queries. In an example, the creative may be created based on information provided by the search engine server 110 about each search query. For example, the search engine server 110 may provide the SERPs for each search query. Alternatively, the search engine server 110 may provide a list of search results for a given search query. Additionally, the search engine server 110 may provide other content such as images, audio files, video files, and text that may be relevant to each given search query to enable the ad generating engine server 120 to generate the creatives.

The creative for each search query may include text, a link to the landing page of the creative, an audio file, a video file, an image file, executable code, embedded information and the like. In an implementation, the creative for a search query may be a condensed version of the first SERP for that query. For example, the creative may include a list of the first few search results. In an example, the creative may be an image rendering of an actual SERP page for the search term. The landing page refers to the URL the browser will take the user to when the user clicks on the creative. The landing page for each creative may be the first SERP for that query.

The ad generating engine server 120 may also identify a set of criteria for displaying each creative. For example, the ad generating engine server 120 may determine the targeting criteria for displaying each ad. The targeting criteria may include logic that determines when, to which users, and on what webpages and applications to display the ad. In an example, an ad's targeting criteria may include contextual relevancy of a webpage on which the ad is displayed to the query (e.g., the webpage is topically relevant to the query) and/or that the query is behaviorally relevant to the user to whom the ad is shown. Behaviorally relevant may include search-based targeting (e.g., the user has recently searched for the query or for something related to the query) and interest-based targeting (e.g., the user has recently visited webpages that are topically related to a topic relevant to the query). The targeting criteria may also include information relating to the user's device (e.g., certain properties about the device they are using to access a webpage), the user's geographical location (e.g., only target users in Norway), or the time of day or day of week (e.g., only show the ad between gam and 2 pm on the weekend). Furthermore, the targeting criteria may include a requirement that the user has access to the search engine server 110. For example, if the search engine server 110 is an enterprise search engine, it may be important to show ads displaying search results provided by the search engine to only those enterprise users that have access to the search engine. In an implementation, this could be defined through, for example, setting a cookie on the search engine. The cookie may operate to define the set of users that should receive the ad (e.g., the audience for the ad) through the cookie's value. This value may then be communicated to the advertising platform that's responsible for distributing the ad. In an example, this may be done via cookie syncing.

The advertising server 130 may include an advertising platform (e.g., advertising networks such as Google DoubleClick) that may receive the creatives and the targeting criteria for each creative from the ad generating engine server 120 and enable displaying the creatives on webpages and applications in accordance with the targeting criteria.

The network 150 may be a wired or wireless network(s) or a combination of wired and wireless networks that connect one or more elements of the system 100. The system 100 may also include the client device 160, which may be connected via the network 150 to the search engine server 110 and the advertising server 130. The client device 160 may be any type of device that can receive input from a user and communicate with the network 150 to send and receive information. Such client devices may include personal or handheld computing devices having or being connected to both input and output elements. For example, client devices 160 may be one of: a mobile telephone; a smart phone; a tablet; a phablet; a smart watch; a wearable computer; a personal computer; a desktop computer; a laptop computer; a gaming device/computer; a television; a thick client; a thin client; a browser-based client; an application executing on a device; an embedded widget operating on a device and the like. This list is for example purposes only and should not be considered as limiting.

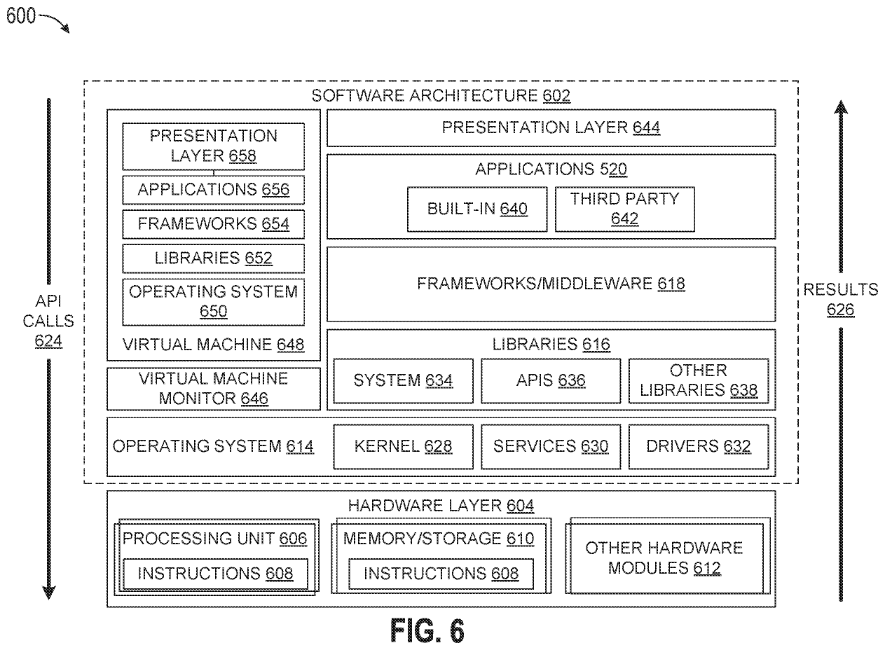

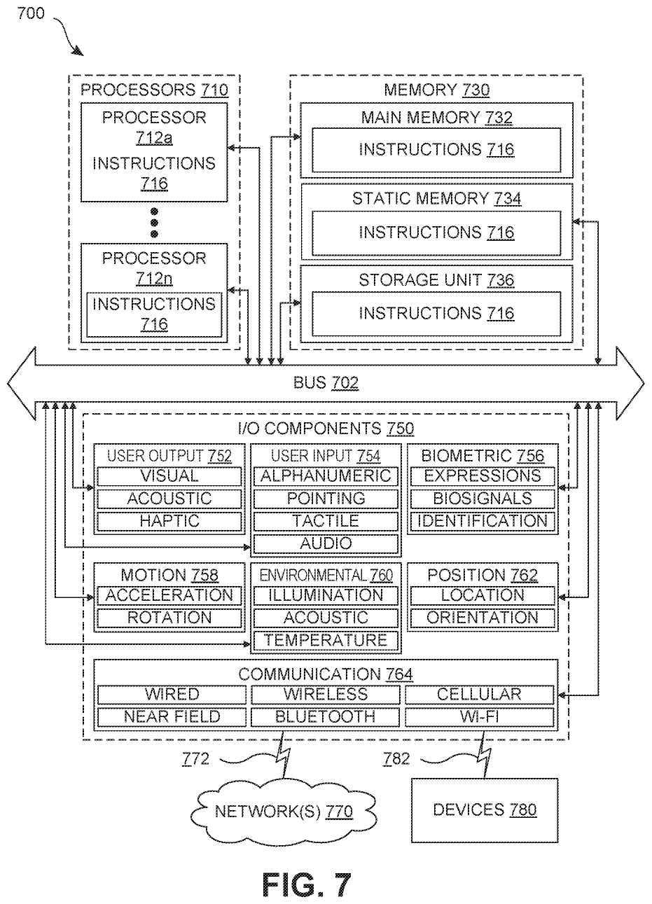

In one implementation, the client device 160 may include a user agent 170 in communication with an input/output element 180. The user agent 240 may be a browser executing on the client device 160 that enables the client device 160 to access a search engine webpage associated with the search engine server 110 to perform a search for a query. In an example, the user agent 170 may provide a UI that allows the user to interact with the search engine server 110. The UI may be displayed on a display device of the client device 160 by utilizing for example the user agent 170 and the input/output element 180. In some examples, the user agent 170 may be a dedicated client application that also provides access to the advertising server 130 thus enabling the advertising server 130 to display ads on webpages visited by the user using the client device 160. The internal hardware structure of a client device is discussed in greater detail in regard to FIGS. 6 and 7.

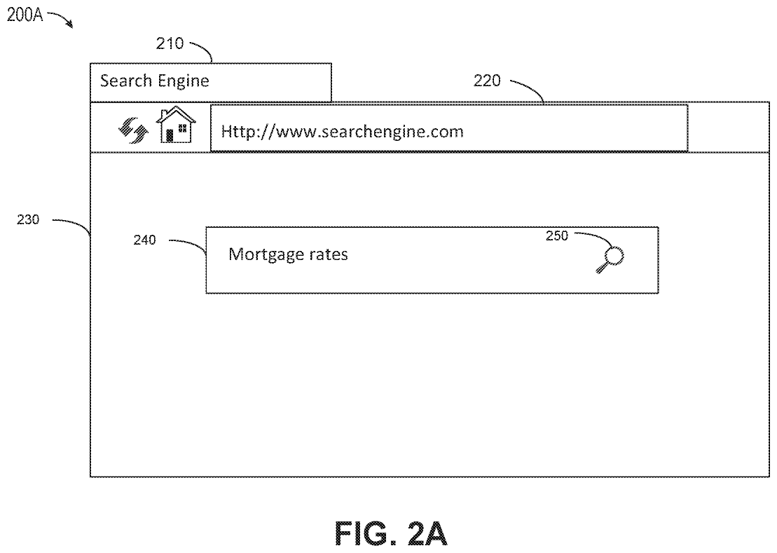

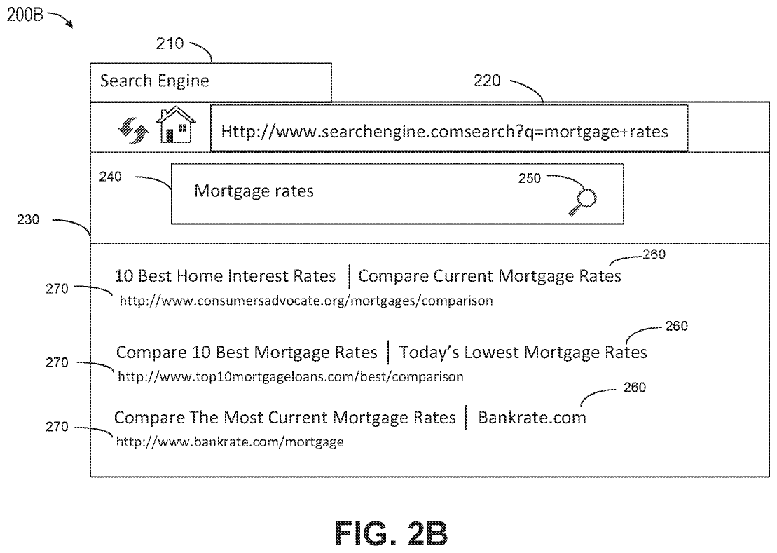

FIGS. 2A-2B illustrate example UI screens associated with a search engine which may be presented to a user for conducting a search. The UI screen 200A of FIG. 2A may for example be displayed by a browser showing a search engine web page. The UI screen 200A may include a canvas 210 (e.g., a tab) associated with the search engine webpage, an address bar 220 displaying the URL for the search engine and a content pane 230 for presenting the content of the webpage. For the search engine webpage, the content pane may include an input box 240 for entering a search term and a search menu icon 250 upon selection of which the search engine may conduct a search for the entered search term. For example, the user may enter the search term “mortgage rates” and press the menu icon 250 to initiate a search.

Once the search is initiated, the browser may display the UI screen 200B of FIG. 2B to show the search results for the entered search term. The UI screen 200B may include the canvas 210, the address bar 220 and the content pane 230. However, in addition to the input box 240, the content pane 230 may also display a list of the search results found for the search term, each of which may include a title 260 and a URL 270. For example, the search results may also include a short summary about each result, one or more images or videos associated with the results, and the like. Information provided about the search results may vary depending on the search term and/or the type of search results requested. For example, if the search query includes the word “image” (e.g., images of dogs), the search results may include thumbnails of images of dogs provided by the search results. Similarly, a search for “video’ may include thumbnails of videos relating to the search query. Images, videos and other specific content may also be provided when the search engine webpage provides a mechanism for the user to identify the type of results requested or when the search engine groups together different types of results based on their types. Regardless of the manner in which the search results are displayed, the search results page provided may be used as a landing page for a creative designed to provide search results to users who may have an interest in the search term.

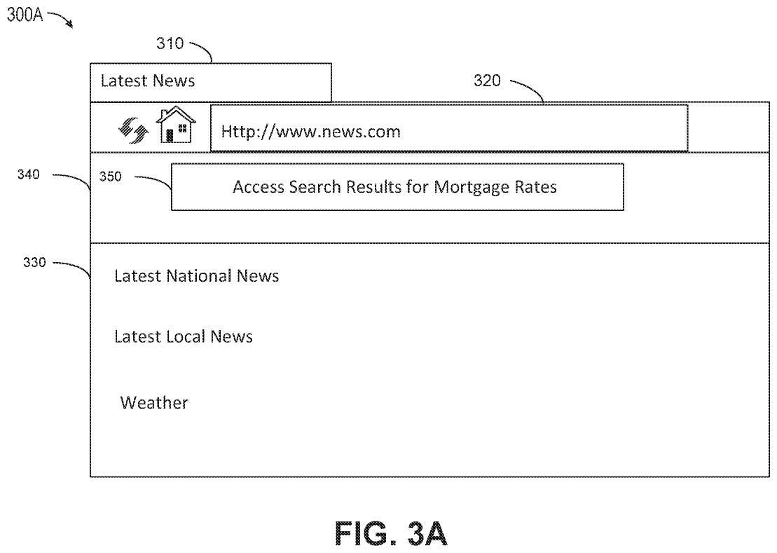

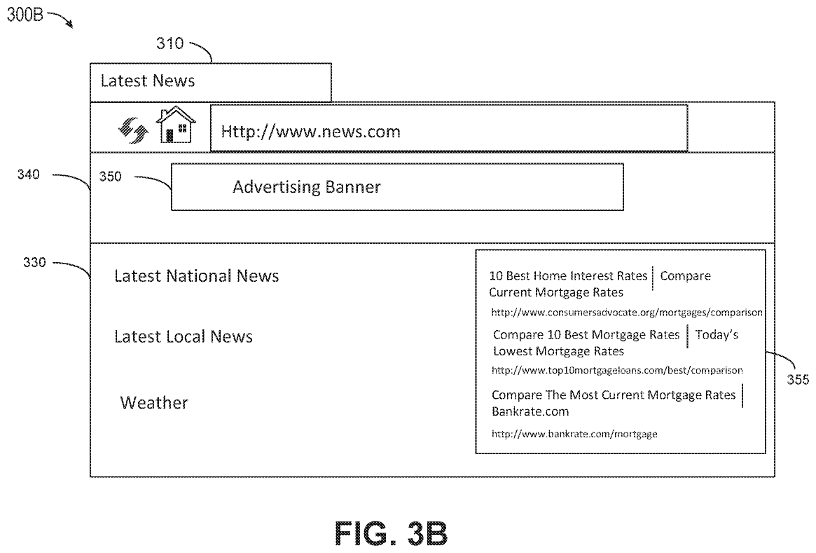

FIGS. 3A-3B illustrate example UI screens of webpages displaying search result ads. The UI screen 300A of FIG. 3A may for example be displayed by a browser showing a news webpage. The UI screen 300A may include a canvas 310 (e.g., a tab) associated with the news webpage, an address bar 320 displaying the URL for the search engine and a content pane 330 for presenting the content of the webpage. The content pane 330 may include a portion 340 designated for displaying ads such as the banner ad 350. As shown, the banner ad 350 may display a creative designed to bring the user's attention to a search term that may be of interest to them. For example, if the user has recently searched for mortgage rates or has been visiting the mortgage rate sections of various webpages, information relating to such user use history may be accessed by the advertising server (e.g., advertising network used to provide ads for the browser or the webpage) and used to determine that the user may have an interest in mortgage rates and should be provided with an ad that enables them to retrieve the latest search results relating to mortgage rates.

In one implementation, the search result ad may simply be created based on the webpage being visited. For example, an ad for a SERP that is relevant to the webpage currently being visited could be created and displayed. This may be done by reviewing click-through logs to examine historical queries associated with the webpage the user is currently viewing in their browser. Upon examining the historical queries, a creative may be displayed on the page that has a SERP generated from the best click-through queries for that page as its landing page. This can be very useful for users as it may operate as an assistant that automatically identifies the best search results associated with a webpage being viewed.

The creative for the ad 350 may be as simple as a template that incorporates the search term. For example, the creative may simply contain text stating “Access Search Results for ‘search term.’” The template may place the actual search term (e.g., mortgage rate) in the position provided in the template to complete the creative. This may provide a simple way of informing the user that search results relating to a query interested to them may be available at the landing page provided by the ad. Alternatively, the creative may incorporate various types of text and/or media content to provide a more enticing ad. Upon clicking on the ad 350, the browser may display the SERP associated with the search term “mortgage rates” (e.g., UI screen 200B).

It should be noted that even though the ad 350 is displayed in the portion 340 of UI screen 300A, the ad 350 could be positioned in any location within the content pane of the UI screen. For example, the ad may be incorporated within the actual content of the webpage (e.g., in the middle of the webpage, on the bottom of the webpage or on the side of the webpage). FIG. 3B depicts an example UI screen 300B which displays an ad 355 on the right side of the content pane 330. The ad 355 may be shown in addition to the ad 350 which is shown in the portion 340 or it may be shown by itself (e.g., no ad is shown on top of the webpage).

The ad 355 displays an alternative creative for displaying an ad for search results. The creative for the ad 355 may be a thumbnail of a portion of the first SERP associated with the search term. In this manner, the creative may not only provide information about the search term for which search results are available, but also provide a listing of some of the top search results to for example enable the user to decide whether he/she is interested in visiting the SERP. As an alternative to providing a thumbnail that includes all the information provided in the SERP, the create may include a summarized version of the SERP. For example, the creative may only contain the titles and not the URLs. For SERPs that include images or videos, the SERP may include only a portion of those images and/or videos. Other configurations are also possible. In an example, the creative may include a combination of the text template discussed above and information (e.g., text, images, video, audio, etc.) extracted from the SERP.

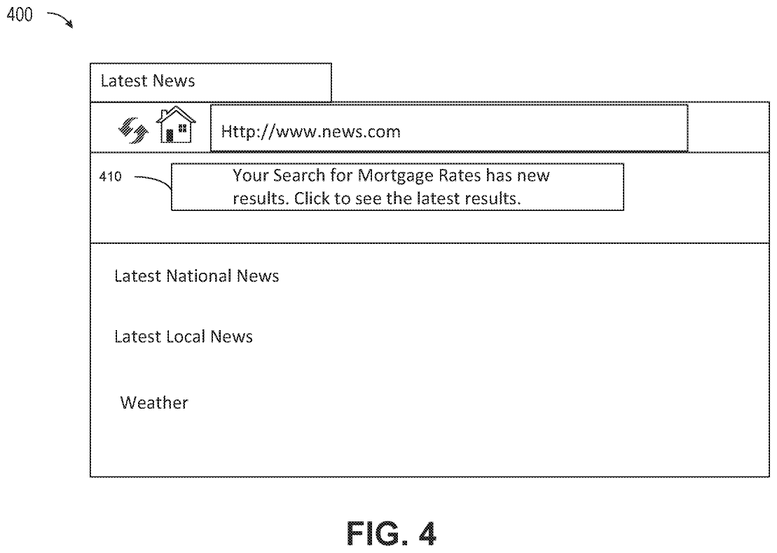

The search result ads discussed herein may not only provide a way for a user to quickly access search results, but also notify a user when new results become available. FIG. 4 depicts an example UI screen 400 that displays an ad 410 notifying a user that a new search result has become available. This may be achieved by storing a user's search history for a predetermined period of time. For example, the search engine may set a cookie that stores a user's searches. The advertising server may then determine if one or more of the user's recent searches coincides with or relates to a search term for which an ad has been generated and if so whether new search results are available for such a search. To determine if new search results are available, the search engine may occasionally (e.g., based on a predetermined schedule or based on certain other triggering events) execute searches for the identified search queries for which ads are created. For example, the search engine may perform searches once every 24 hours for the identified search queries. The top search results (e.g., the top 20 search results) may then be compared with the previous top search results for the same query to determine if any new search results have become available.

When new search results are identified for a search term, the search engine may notify the ad generating engine to generate a new creative for the search term and/or to notify the advertising server to modify the targeting criteria for the search term. For example, the ad generating engine may generate a creative such as the ad 410 that notifies the user new search results are available for the search term. This may involve using a template that places the search term in a predetermined position in the text. Many other configurations or designs for the creative may be used. For example, the creative may include all or a portion of the new search result (e.g., the title, the URL, a thumbnail, or a description).

The landing page for the new creative may be the new SERP which includes the one or more new search results. The new creative may then be transmitted to the advertising service with targeting criteria that includes users that have searched for the particular search term and/or search terms closely related to it in a predetermined time period (e.g., in the last seven days).

This results in the users being easily and efficiently notified of relevant new search results that have become available for queries for which they have a particular interest. Thus, a search engine can meet the user's needs where they are browsing. Furthermore, this can lead to an increase in the use of the search engine which may be desirable for the search engine.

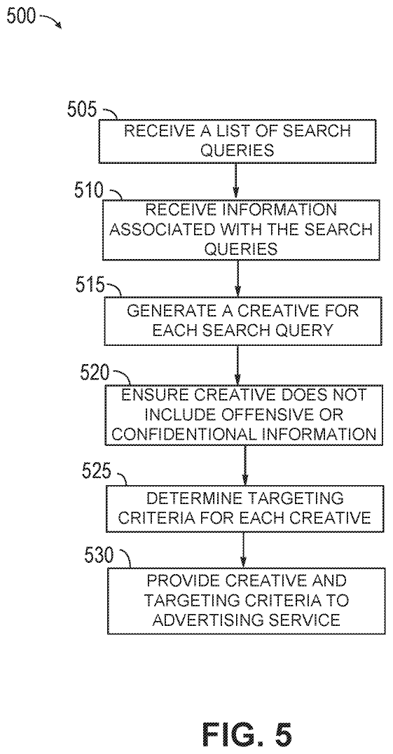

FIG. 5 is a flow diagram depicting an example method 500 for providing search results as advertisements. In one implementation, method 500 may be performed by a computer program such as the ad generating engine discussed above. The program may include one or more machine learning (ML) models for performing different aspects of the process, as discussed further below.

At 505, method 500 may begin by receiving a list of search queries. The list may include multiple search queries (e.g., search terms) that have been identified as being appropriate for including in a list of search terms for which ads should be generated. In one implementation, the list may be provided by a search engine. For example, a search engine may provide a list of the topmost searched for queries in a specific given time period (e.g. top 200 search queries in the last 24 hours). Other factors may also be taken into account in determining the list. For example, preference may be given to search terms for which the results were more likely to be used (e.g., resulted in more clicks), or those which included more sponsored search results. Many other parameters may also be considered. In an example, the required parameters may be set by the ad generating engine and transmitted to a search engine to request a specific type of list. Because some of the parameters may change with time, the list may need to be updated regularly. For example, if one of the factors include the topmost search queries, the list may need to be updated frequently to ensure it reflects the latest trends. Updating the list may involve determining if any search queries should be added to or removed from a previous list and sending those changes to the ad generating engine to modify the ads accordingly.

It should be noted that different search engines may rely on different types of parameters for identifying the list of search queries. For example, a public search engine may need to rely on different types of factors than an enterprise search engine. As a result, the ad generating engine may set different parameters for different types of search engines.

In addition to the list of search queries, information associated with each of the search queries may also be received, at 510. The information may include the URLs for one or more SERPs associated with a search query, the top search results associated with the search query, information that can be used to generate the creative for the search query (e.g., text, images, video or audio files retrieved from the search engine relating which may or may not be directly related to the search query), and targeting criteria for a search query. This information may be provided by the search engine based on data collected and stored by the search engine. The information may also include a list of search terms that are related to a query. Alternatively, a list of terms relating to a query may be identified by the ad generating engine by for example using an ML model.

Once the list of search queries and information related to them are received, method 500 may proceed to generate a creative for each search query for which a creative has not already been prepared, at 515. This may include new items in the list of search queries if the list is an updated list or all items in the list, if the list is a new list. The creative may be generated automatically based on a variety of predetermined criteria. For example, one or more templates may be used for different types of search queries. In an example, if the search query relates to a product or another item for which an image has been provided, the template may make use of the image. In another example, the template may utilize a standard image (e.g., a logo associated with the search engine). In another example, the size, shape and design of the creative may depend on the type of ad that will be displayed for the search term. For example, banner ads may include minimal information, while larger ads may include more information (e.g., a summary of the SERP).

In one implementation, some of the creatives may be generated manually or may include manual steps such as manual inspection by a human. For example, some ads may require more creatively and/or a more elaborate design, in which case a designer may become involved in preparing the creative. Whether the creative is designed automatically or manually, an inspection may be performed, at 520, to ensure that the creative does not include offensive or confidential information. For example, for creatives that make use of the top search results for a search term or provide a snapshot or thumbnail of one of the SERPs, it may be important to check to ensure the information that was retrieved to generate the creative does not include language that may be offensive to users. This may need to be performed manually. Alternatively, a ML model may be trained to identify and tag offensive content such as offensive language, images or videos.

For an enterprise search engine, in addition to looking for offensive language, the content may need to be examined to ensure it does not include confidential information. For example, some enterprise clients may have access to information that others do not. To ensure compliance with confidentiality and privacy policies, when a search for a query is done by an enterprise search engine, the results provided may vary depending on the level of access of a user. In such cases, the information provided by the search engine may already include a list of authorized users, their level of access and the like. However, to provide more protection against inadvertent disclosure, human or automatic inspection may occur at this stage to ensure the creative does not include any confidential information.

Once the creatives are generated, method 500 may proceed to determine the targeting criteria for each creative, at 525. The targeting criteria may include logic that determines which users an ad should be displayed for, when the ad should be displayed for each user, and/or where (which webpages or applications) to display the ad on. An ad's targeting criteria may include criteria that relaters to contextual relevancy of the user and/or the webpage on which the ad is shown to the query. In an example, the criteria may also include a requirement that the user have access to the search engine providing the ad (e.g., for enterprise search engines). This could be defined through a cookie set on the search engine. In another example, the targeting criteria may include a criterion for users that having a standing query for a search term. In such an instant, the targeting criteria may include displaying an ad to the user when updated search results for the standing query become available.

Contextual relevancy may include requiring that the page where the ad is shown be topically relevant to the query, or that the query be behaviorally relevant to the user to whom the ad is shown. Behaviorally relevant may include both search-based retargeting (e.g., the user has recently searched for this query or something related) and interest-based targeting (e.g., the user has recently visited webpages related to topics relevant to the query).

To determine the most effective targeting criteria for search result ads, user data may be collected to train one or more ML models that identify the types of users an ad should be displayed to (e.g., the degree of relevancy required), the best time or date to display an ad, and/or the most appropriate webpages or applications to display the ad on. The data collected may determine when users click on search result ads, determine and collect factors associated with the ad, and identify those factors that lead to more clicks. The factors associated with an ad may include the type of webpage it was displayed on, date and the time of day, the time period within which the user had searched for the search term prior to being shown the ad, how often had the user searched for the query, how closely related the search term used by the user is to the search query of the ad, and the like. By examining these factors and relationships between them, a ML model may be trained that identifies factors that are most likely to result in ads that are of interest to users. For example, it may be determined that an ad displaying search results for mortgage rates is most likely to result in clicks when it is displayed on financial institution's websites during business hours to users who have searched for houses for sale in the past week. These criteria may then be associated with the creative and stored in a dataset along with the creative for transmission to an advertising service. In one implementation, the ML models are utilized by the advertising platform and as such at least part of the targeting criteria may be provided by the advertising service.

In one implementation, the targeting criteria may need to be updated occasionally. For example, the conditions under which users click on ad may change depending on the latest trends or the latest news. As a result, the conditions for each creative may be examined occasionally either based on a predetermined schedule or dynamically upon certain occurrences. The examination may lead to the targeting criteria for the creative being changed, in which case the updated targeting criteria may be associated with the creative.

Once the targeting criteria for each creative has been determined, the creative along with the targeting criteria may be provided to an advertising service, at 530. The advertising service may then utilize the targeting criteria to display the creative accordingly, based on mechanism that are known in the art.

As discussed above, in different implementations, a training system may be used that includes an initial ML model (which may be referred to as an “ML model trainer”) configured to generate a subsequent trained ML model from training data obtained from a training data repository or from device-generated data. The generation of this ML model may be referred to as “training” or “learning.” The training system may include and/or have access to substantial computation resources for training, such as a cloud, including many computer server systems adapted for machine learning training. In some implementations, the ML model trainer is configured to automatically generate multiple different ML models from the same or similar training data for comparison. For example, different underlying ML algorithms may be trained, such as, but not limited to, decision trees, random decision forests, neural networks, deep learning (for example, convolutional neural networks), support vector machines, regression (for example, support vector regression, Bayesian linear regression, or Gaussian process regression). As another example, size or complexity of a model may be varied between different ML models, such as a maximum depth for decision trees, or a number and/or size of hidden layers in a convolutional neural network. As another example, different training approaches may be used for training different ML models, such as, but not limited to, selection of training, validation, and test sets of training data, ordering and/or weighting of training data items, or numbers of training iterations. One or more of the resulting multiple trained ML models may be selected based on factors such as, but not limited to, accuracy, computational efficiency, and/or power efficiency. In some implementations, a single trained ML model may be produced.

The training data may be continually updated, and one or more of the models used by the system can be revised or regenerated to reflect the updates to the training data. Over time, the training system (whether stored remotely, locally, or both) can be configured to receive and accumulate more and more training data items, thereby increasing the amount and variety of training data available for ML model training, resulting in increased accuracy, effectiveness, and robustness of trained ML models.

Thus, in different implementations, a technical solution may be provided to enable displaying ads to potentially interested users for search results of specific search queries. The search results ads may make use of advertising space on a webpage or application to notify a user that search results for a query they may be interested in are available at the landing page of the ad. In this manner, search results for information the user is interested in can be easily and efficiently accessed, in effect turning a variety of webpages into potential SERPs for specific search engines. Thus, the technical solution makes use of infrastructure that is already available for displaying ads to turn ads into messaging channels via which search engine results can be provided. This not only increases efficiency and user convenience; it may also help encourage use of particular search engines. Furthermore, the ads can be used as potential channels via which a user can be notified of standing search queries, where if new search results become available for a query the user searched for in the past, ads can be used to notify the user of the new search results.

FIG. 6 is a block diagram 600 illustrating an example software architecture 602, various portions of which may be used in conjunction with various hardware architectures herein described, which may implement any of the above-described features. FIG. 6 is a non-limiting example of a software architecture and it will be appreciated that many other architectures may be implemented to facilitate the functionality described herein. The software architecture 602 may execute on hardware such as client devices, native application provider, web servers, server clusters, external services, and other servers. A representative hardware layer 604 includes a processing unit 606 and associated executable instructions 608. The executable instructions 608 represent executable instructions of the software architecture 602, including implementation of the methods, modules and so forth described herein.

The hardware layer 604 also includes a memory/storage 610, which also includes the executable instructions 608 and accompanying data. The hardware layer 604 may also include other hardware modules 612. Instructions 608 held by processing unit 608 may be portions of instructions 608 held by the memory/storage 610.

The example software architecture 602 may be conceptualized as layers, each providing various functionality. For example, the software architecture 602 may include layers and components such as an operating system (OS) 614, libraries 616, frameworks 618, applications 620, and a presentation layer 624. Operationally, the applications 620 and/or other components within the layers may invoke API calls 624 to other layers and receive corresponding results 626. The layers illustrated are representative in nature and other software architectures may include additional or different layers. For example, some mobile or special purpose operating systems may not provide the frameworks/middleware 618.

The OS 614 may manage hardware resources and provide common services. The OS 614 may include, for example, a kernel 628, services 630, and drivers 632. The kernel 628 may act as an abstraction layer between the hardware layer 604 and other software layers. For example, the kernel 628 may be responsible for memory management, processor management (for example, scheduling), component management, networking, security settings, and so on. The services 630 may provide other common services for the other software layers. The drivers 632 may be responsible for controlling or interfacing with the underlying hardware layer 604. For instance, the drivers 632 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 616 may provide a common infrastructure that may be used by the applications 620 and/or other components and/or layers. The libraries 616 typically provide functionality for use by other software modules to perform tasks, rather than rather than interacting directly with the OS 614. The libraries 616 may include system libraries 634 (for example, C standard library) that may provide functions such as memory allocation, string manipulation, file operations. In addition, the libraries 616 may include API libraries 636 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 616 may also include a wide variety of other libraries 638 to provide many functions for applications 620 and other software modules.

The frameworks 618 (also sometimes referred to as middleware) provide a higher-level common infrastructure that may be used by the applications 620 and/or other software modules. For example, the frameworks 618 may provide various graphic user interface (GUI) functions, high-level resource management, or high-level location services. The frameworks 618 may provide a broad spectrum of other APIs for applications 620 and/or other software modules.

The applications 620 include built-in applications 620 and/or third-party applications 622. Examples of built-in applications 620 may include, but are not limited to, a contacts application, a browser application, a location application, a media application, a messaging application, and/or a game application. Third-party applications 622 may include any applications developed by an entity other than the vendor of the particular system. The applications 620 may use functions available via OS 614, libraries 616, frameworks 618, and presentation layer 624 to create user interfaces to interact with users.

Some software architectures use virtual machines, as illustrated by a virtual machine 628. The virtual machine 628 provides an execution environment where applications/modules can execute as if they were executing on a hardware machine (such as the machine 600 of FIG. 6, for example). The virtual machine 628 may be hosted by a host OS (for example, OS 614) or hypervisor, and may have a virtual machine monitor 626 which manages operation of the virtual machine 628 and interoperation with the host operating system. A software architecture, which may be different from software architecture 602 outside of the virtual machine, executes within the virtual machine 628 such as an OS 650, libraries 652, frameworks 654, applications 656, and/or a presentation layer 658.

FIG. 7 is a block diagram illustrating components of an example machine 700 configured to read instructions from a machine-readable medium (for example, a machine-readable storage medium) and perform any of the features described herein. The example machine 700 is in a form of a computer system, within which instructions 716 (for example, in the form of software components) for causing the machine 700 to perform any of the features described herein may be executed. As such, the instructions 716 may be used to implement methods or components described herein. The instructions 716 cause unprogrammed and/or unconfigured machine 700 to operate as a particular machine configured to carry out the described features. The machine 700 may be configured to operate as a standalone device or may be coupled (for example, networked) to other machines. In a networked deployment, the machine 700 may operate in the capacity of a server machine or a client machine in a server-client network environment, or as a node in a peer-to-peer or distributed network environment. Machine 700 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 700 is illustrated, the term “machine” includes a collection of machines that individually or jointly execute the instructions 716.

The machine 700 may include processors 710, memory 730, and I/O components 750, which may be communicatively coupled via, for example, a bus 702. The bus 702 may include multiple buses coupling various elements of machine 700 via various bus technologies and protocols. In an example, the processors 710 (including, for example, a central processing unit (CPU), a graphics processing unit (GPU), a digital signal processor (DSP), an ASIC, or a suitable combination thereof) may include one or more processors 712a to 712n that may execute the instructions 716 and process data. In some examples, one or more processors 710 may execute instructions provided or identified by one or more other processors 710. The term “processor” includes a multi-core processor including cores that may execute instructions contemporaneously. Although FIG. 7 shows multiple processors, the machine 700 may include a single processor with a single core, a single processor with multiple cores (for example, a multi-core processor), multiple processors each with a single core, multiple processors each with multiple cores, or any combination thereof. In some examples, the machine 700 may include multiple processors distributed among multiple machines.

The memory/storage 730 may include a main memory 732, a static memory 734, or other memory, and a storage unit 736, both accessible to the processors 710 such as via the bus 702. The storage unit 736 and memory 732, 734 store instructions 716 embodying any one or more of the functions described herein. The memory/storage 730 may also store temporary, intermediate, and/or long-term data for processors 710. The instructions 716 may also reside, completely or partially, within the memory 732, 734, within the storage unit 736, within at least one of the processors 710 (for example, within a command buffer or cache memory), within memory at least one of I/O components 750, or any suitable combination thereof, during execution thereof. Accordingly, the memory 732, 734, the storage unit 736, memory in processors 710, and memory in I/O components 750 are examples of machine-readable media.

As used herein, “machine-readable medium” refers to a device able to temporarily or permanently store instructions and data that cause machine 700 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 716) for execution by a machine 700 such that the instructions, when executed by one or more processors 710 of the machine 700, cause the machine 700 to perform and one or more of the features described herein. Accordingly, a “machine-readable medium” may refer to a single storage device, as well as “cloud-based” storage systems or storage networks that include multiple storage apparatus or devices.

The I/O components 750 may include a wide variety of hardware components adapted to receive input, provide output, produce output, transmit information, exchange information, capture measurements, and so on. The specific I/O components 750 included in a particular machine will depend on the type and/or function of the machine. For example, mobile devices such as mobile phones may include a touch input device, whereas a headless server or IoT device may not include such a touch input device. The particular examples of I/O components illustrated in FIG. 7 are in no way limiting, and other types of components may be included in machine 700. The grouping of I/O components 750 are merely for simplifying this discussion, and the grouping is in no way limiting. In various examples, the I/O components 750 may include user output components 752 and user input components 754. User output components 752 may include, for example, display components for displaying information (for example, a liquid crystal display (LCD) or a projector), acoustic components (for example, speakers), haptic components (for example, a vibratory motor or force-feedback device), and/or other signal generators. User input components 754 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 750 may include biometric components 756 and/or position components 762, among a wide array of other environmental sensor components. The biometric components 756 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 762 may include, for example, location sensors (for example, a Global Position System (GPS) receiver), altitude sensors (for example, an air pressure sensor from which altitude may be derived), and/or orientation sensors (for example, magnetometers).

The I/O components 750 may include communication components 764, implementing a wide variety of technologies operable to couple the machine 700 to network(s) 770 and/or device(s) 780 via respective communicative couplings 772 and 782. The communication components 764 may include one or more network interface components or other suitable devices to interface with the network(s) 770. The communication components 764 may include, for example, components adapted to provide wired communication, wireless communication, cellular communication, Near Field Communication (NFC), Bluetooth communication, Wi-Fi, and/or communication via other modalities. The device(s) 780 may include other machines or various peripheral devices (for example, coupled via USB).

In some examples, the communication components 764 may detect identifiers or include components adapted to detect identifiers. For example, the communication components 664 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 762, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-5) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the following, further features, characteristics and advantages of the invention will be described by means of items:

Item 1. A data processing system comprising:

a processor; and

a memory in communication with the processor, the memory storing executable instructions that, when executed by the processor, cause the data processing system to perform functions of:
receiving over a network a search term for which a targeted notification is to be generated;
receiving data associated with the search term;
generating a creative for the targeted notification based at least in part on the data received and the search term;
determining targeting criteria for the targeted notification; and
providing the creative and the targeting criteria to an advertising service over the network to enable displaying the targeted notification,
wherein:
   the targeted notification provides notification of search results available for the search term, and
   a landing page for the creative is a search engine results page (SERP) for the search term.

Item 2. The data processing system of item 1, wherein the data associated with the search term includes at least one of a uniform resource locator (URL) for the SERP, one or more top search results for the search term, and text or image that can be used in generating the creative.

Item 3. The data processing system of items 1 or 2, wherein the search term is received from a search engine.

Item 4. The data processing system of any of the preceding items, wherein the search term is identified by the search engine as being a query for which the targeted notification should be generated.

Item 5. The data processing system of any of the preceding items, wherein the search engine identifies the search term from among a plurality of queries, identification being based on at least one of a frequency with which the search term is searched for in the search engine in a given time period, and on a number of times search results provided for the search term were used.

Item 6. The data processing system of any of the preceding items, wherein the targeting criteria includes at least one of one or more conditions for types of users to which the targeted notification should be displayed, a time period during which the targeted notification should be displayed, and a location at which the targeted notification should be displayed.

Item 7. The data processing system of any of the preceding items, wherein the location includes a webpage and an application.

Item 8. The data processing system of any of the preceding items, wherein the location may be determined based on contextual relevancy of contents of the location to the search term.

Item 9. The data processing system of any of the preceding items, wherein the one or more conditions for the types of users are determined by examining a search history.

Item 10. A method for enabling display of a targeted notification, the method comprising:
receiving over a network a search term for which the targeted notification is to be generated;
receiving data associated with the search term;
generating a creative for the targeted notification based at least in part on the data received and the search term;
determining targeting criteria for the targeted notification; and
providing the creative and the targeting criteria to an advertising service over the network to enable displaying the targeted notification,
wherein:
   the targeted notification provides notification of search results available for the search term, and
   a landing page for the creative is a search engine results page (SERP) for the search term.

Item 11. The method of item 10, wherein the data associated with the search term includes at least one of a uniform resource locator (URL) for the SERP, one or more top search results for the search term, and text or image that can be used in generating the creative.

Item 12. The method of items 10 and 11, wherein the search term is received from a search engine.

Item 13. The method of any of items 10-12, wherein the targeting criteria includes at least one of one or more conditions for types of users to which the targeted notification should be displayed, a time period during which the targeted notification should be displayed, and a location at which the targeted notification should be displayed.

Item 14. The method of any of items 10-13, wherein the location includes a webpage and an application.

Item 15. The method of any of items 10-14, wherein the location may be determined based on contextual relevancy of contents of the location to the search term.

Item 16. The method of claim any of items 10-15, further comprising:
receiving an indication that a new search result is available for the search term;
updating the creative based on the new search result;
determining updated targeting criteria for the search term; and
providing the updated creative and the updated targeting criteria to the advertising service.

Item 17. The method of claim 16, wherein the updated targeting criteria includes a list of users who have searched for the search term within a predetermined time period prior to the new search result becoming available.

Item 18. A non-transitory computer readable medium on which are stored instructions that when executed cause a programmable device to:
receive over a network a search term for which a targeted notification is to be generated;
receive data associated with the search term;
generate a creative for the targeted notification based at least in part on the data received and the search term;
determine targeting criteria for the targeted notification; and
provide the creative and the targeting criteria to an advertising service over the network to enable displaying the targeted notification,
wherein:
   the targeted notification provides notification of search results available for the search term, and
   a landing page for the creative is a search engine results page (SERP) for the search term.

Item 19. The non-transitory computer readable medium of item 18, wherein the data associated with the search term includes at least one of a uniform resource locator (URL) for the SERP, one or more top search results for the search term, and text or image that can be used in generating the creative.

Item 20. The non-transitory computer readable medium of items 18 or 19, wherein the targeting criteria includes at least one of one or more conditions for types of users to which the targeted notification should be displayed, a time period during which the targeted notification should be displayed, and a location at which the targeted notification should be displayed.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory in communication with the processor, the memory storing executable instructions that, when executed by the processor, cause the data processing system to perform functions of:
receiving over a network a search term for which a targeted notification is to be generated;
receiving data associated with the search term;
generating a creative for the targeted notification based at least in part on the data received and the search term;
determining targeting criteria for the targeted notification; and
providing the creative and the targeting criteria to an advertising service over the network to enable displaying the targeted notification,
wherein:
the targeted notification provides notification of search results available for the search term, and
a landing page for the creative is a search engine results page (SERP) for the search term.

2. The data processing system of claim 1, wherein the data associated with the search term includes at least one of a uniform resource locator (URL) for the SERP, one or more top search results for the search term, and text or image that can be used in generating the creative.

3. The data processing system of claim 1, wherein the search term is received from a search engine.

4. The data processing system of claim 3, wherein the search term is identified by the search engine as being a query for which the targeted notification should be generated.

5. The data processing system of claim 4, wherein the search engine identifies the search term from among a plurality of queries, identification being based on at least one of a frequency with which the search term is searched for in the search engine in a given time period, and on a number of times search results provided for the search term were used.

6. The data processing system of claim 1, wherein the targeting criteria includes at least one of one or more conditions for types of users to which the targeted notification should be displayed, a time period during which the targeted notification should be displayed, and a location at which the targeted notification should be displayed.

7. The data processing system of claim 6, wherein the location includes a webpage and an application.

8. The data processing system of claim 6, wherein the location may be determined based on contextual relevancy of contents of the location to the search term.

9. The data processing system of claim 6, wherein the one or more conditions for the types of users are determined by examining a search history.

10. A method for enabling display of a targeted notification, the method comprising:
receiving over a network a search term for which the targeted notification is to be generated;
receiving data associated with the search term;
generating a creative for the targeted notification based at least in part on the data received and the search term;
determining targeting criteria for the targeted notification; and
providing the creative and the targeting criteria to an advertising service over the network to enable displaying the targeted notification,
wherein:
the targeted notification provides notification of search results available for the search term, and
a landing page for the creative is a search engine results page (SERP) for the search term.

11. The method of claim 10, wherein the data associated with the search term includes at least one of a uniform resource locator (URL) for the SERP, one or more top search results for the search term, and text or image that can be used in generating the creative.

12. The method of claim 10, wherein the search term is received from a search engine.

13. The method of claim 10, wherein the targeting criteria includes at least one of one or more conditions for types of users to which the targeted notification should be displayed, a time period during which the targeted notification should be displayed, and a location at which the targeted notification should be displayed.

14. The method of claim 13, wherein the location includes a webpage and an application.

15. The method of claim 13, wherein the location may be determined based on contextual relevancy of contents of the location to the search term.

16. The method of claim 10, further comprising:
receiving an indication that a new search result is available for the search term;
updating the creative based on the new search result;
determining updated targeting criteria for the search term; and
providing the updated creative and the updated targeting criteria to the advertising service.

17. The method of claim 16, wherein the updated targeting criteria includes a list of users who have searched for the search term within a predetermined time period prior to the new search result becoming available.

18. A non-transitory computer readable medium on which are stored instructions that when executed cause a programmable device to:
receive over a network a search term for which a targeted notification is to be generated;
receive data associated with the search term;
generate a creative for the targeted notification based at least in part on the data received and the search term;
determine targeting criteria for the targeted notification; and
provide the creative and the targeting criteria to an advertising service over the network to enable displaying the targeted notification,
wherein:
the targeted notification provides notification of search results available for the search term, and
a landing page for the creative is a search engine results page (SERP) for the search term.

19. The non-transitory computer readable medium of claim 18, wherein the data associated with the search term includes at least one of a uniform resource locator (URL) for the SERP, one or more top search results for the search term, and text or image that can be used in generating the creative.

20. The non-transitory computer readable medium of claim 18, wherein the targeting criteria includes at least one of one or more conditions for types of users to which the targeted notification should be displayed, a time period during which the targeted notification should be displayed, and a location at which the targeted notification should be displayed.
